(19) United States
(12) Patent Application Publication
(10) Pub. No.: US 2021/0086339 A1
(43) Pub. Date: Mar. 25, 2021

(54) PNEUMATIC DEVICE WITH A QUICK RELEASE STRUCTURE

(71) Applicant: Jian-Shiou LIAW, Taichung City (TW)

(72) Inventor: Jian-Shiou LIAW, Taichung City (TW)

(21) Appl. No.: 16/581,657

(22) Filed: Sep. 24, 2019

(51) Int. Cl. B25D 17/02

(52) U.S. Cl. CPC B25D 17/02; B25D 2250/051; B25D 2250/291

(57) ABSTRACT

A pneumatic device with a quick release structure includes: a housing having a peripheral wall defining an accommodating space for accommodation of an output shaft, and the peripheral wall being provided with a first connecting portion; and a front cover having a second connecting portion which is detachably coupled to the first connecting portion. A user can directly open the front cover to take the needle holder out of the accommodating space, then remove the to-be-replaced rust removing needles and replace them with new ones, then put the needle holder back to the accommodating space, and fix the front cover back to the housing, thus the replacement of the rust removing needles is done. Hence, the replacement speed is fast, and no tools are required during the replacement operation, so that the operation of replacing the rust removing needles is simpler and more intuitive.

### BACKGROUND

### Field of the Invention

The present invention relates to the technical field of pneumatic tools, and in particular to a pneumatic device having a quick release structure.

### Related Prior Art

Generally, the way that a pneumatic tool actuation works can be divided into linear reciprocating and rotary type, and the reciprocating pneumatic tool means that the working end of the tool is in the form of internal and external axial reciprocating advance and retreat, so as to achieve rust removal and cutting, punching, chiseling and other functions.

In general, the conventional reciprocating pneumatic tool is designed such that its one end can be connected to a work head, so that the impact mechanism provided inside the reciprocating pneumatic tool can be driven by air pressure, and then the output shaft disposed therein is driven by the impact mechanism. In particular, depending on the function to be used, the output shaft can be a different workpiece such as a hammer, a rust remover or a shovel, so as to achieve different functions such as chiseling, rust removal or shovel by different workpieces.

It is worth mentioning that when the output shaft of the pneumatic tool needs to be replaced, it has to disassemble by starting from the end that is connected the work head, and the disassembly requires the use of hand tools. Only after the connected work head is removed, the reciprocating pneumatic tool can be opened to take out the internal output shaft and replace it.

However, each time the output shaft is replaced, the reciprocating pneumatic tool must be disassembled from the end connected to the tool, which not only causes inconvenience in replacement, but also causes long replacement time and delays the processing time. In view of this, the inventor of the present invention has invented a pneumatic device with a quick release structure.

### SUMMARY

One objective of the present invention is to solve the drawbacks of the conventional pneumatic tool for taking out the output shaft, which requires additional use of the tool, thereby making the process of replacing the output shaft more convenient.

To achieve the above objective, a pneumatic device with a quick release structure is provided by the invention and comprises:

a housing having a peripheral wall defining an accommodating space for accommodation of an output shaft, and the peripheral wall being provided with a first connecting portion; and

a front cover having a second connecting portion which is detachably coupled to the first connecting portion.

Preferably, the first connecting portion is an inner thread, the second connecting portion is an outer thread for meshing with the first connecting portion in the form of the inner thread.

Preferably, the output shaft includes a needle holder and an impact mechanism, and the needle holder is drivingly connected to the impact mechanism.

Preferably, the needle holder is provided with a plurality of needle apertures, in each of the needle apertures is inserted a rust removing needle which has a head portion and a rust removing rod, and the head portion has a diameter larger than a diameter of each of the needle apertures.

Preferably, the front cover has an abutting surface facing the needle holder, and an elastic member is disposed between the needle holder and the abutting surface.

Preferably, the peripheral wall of the housing has an outer surface which is provided with an anti-skid pattern.

Preferably, a coupling member has a circumferential surface engaged with an inner surface of the peripheral wall, and the coupling member has an inner thread.

Preferably, the coupling member is made of rubber.

Preferably, the coupling member is made of iron or aluminum.

By such arrangements, the user can directly open the front cover to take the needle holder out of the accommodating space, then remove the to-be-replaced rust removing needles from the needle holder and replace them with new ones, and then put the needle holder back to the accommodating space, and finally fix the front cover back to the housing, so that the replacement of the rust removing needles is done. Hence, not only the replacement speed is fast, but the high pressure air pipe does not need to be disassembled during the replacement operation, so that the operation of replacing the rust removing needles is simpler and more intuitive.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A is a perspective view of a preferred embodiment of the present invention;

FIG. 1B is a perspective view of another angle of the present invention in the preferred embodiment;

FIG. 2 is an exploded perspective view of the present invention in the preferred embodiment;

FIG. 3 is a side cross-sectional view of the present invention in the preferred embodiment;

FIG. 4 is a schematic view of a side cross-sectional disassembly of the present invention in the preferred embodiment;

FIG. 5 is a side cross-sectional view of another embodiment of the present invention; and

FIG. 6 is a side cross-sectional view showing another state of the present invention in another preferred embodiment.

### DETAILED DESCRIPTION

The present invention will be clearer from the following description when viewed together with the accompanying drawings, which show, for purpose of illustrations only, the preferred embodiment in accordance with the present invention.

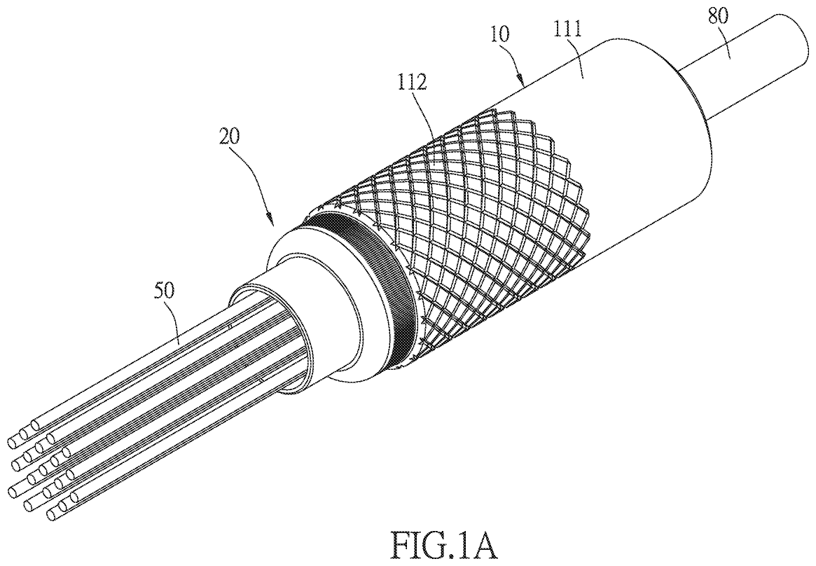

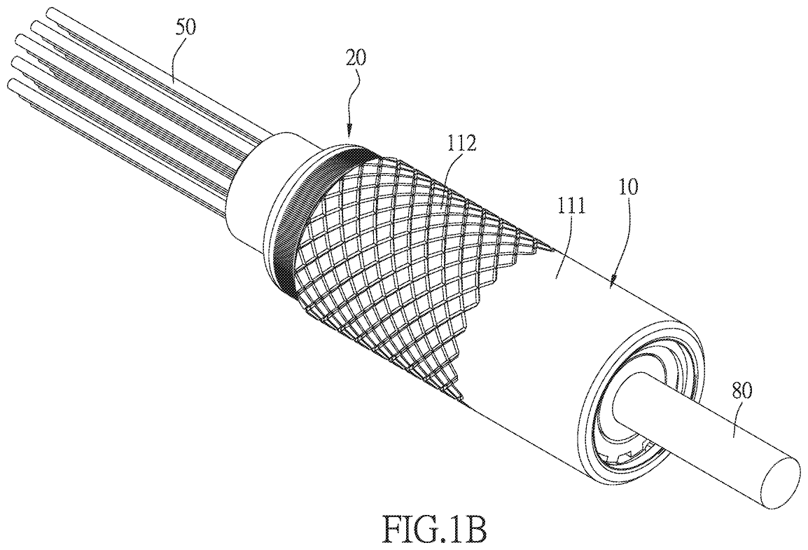

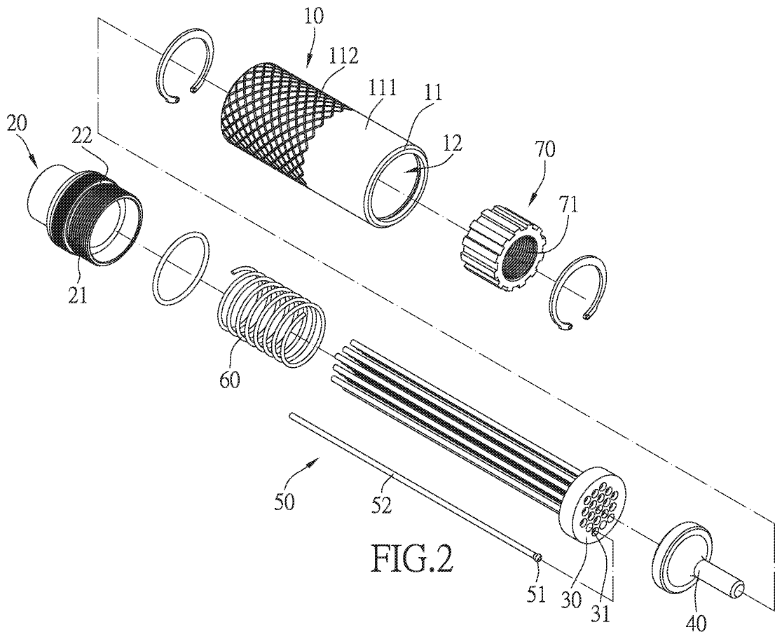

Referring to FIGS. 1A to 3, a pneumatic device with a quick release structure in accordance with the present invention comprises: a housing 10 and a front cover 20.

The housing 10 has a peripheral wall 11 defining an accommodating space 12 for accommodation of an output shaft, and the peripheral wall 11 is provided with a first connecting portion 13. In this embodiment, the first connecting portion 13 is an internal thread disposed on an inner surface of the peripheral wall 11.

The front cover 20 has a second connecting portion 21 which is detachably coupled to the first connecting portion 13. In this embodiment, the second connecting portion 21 is an outer thread to be screwed with the first connecting portion 13.

In this embodiment, the output shaft includes a needle holder 30 and an impact mechanism 40. The needle holder 30 is drivingly connected to the impact mechanism 40, and the impact mechanism 40 is driven by the high pressure gas input by a pneumatic tube to perform reciprocating movement, consequently the impact mechanism 40 drives the needle holder 30 to perform reciprocating movement.

Preferably, the needle holder 30 is provided with a plurality of needle apertures 31, and in each of the needle apertures 31 is inserted a rust removing needle 50 which has a head portion 51 and a rust removing rod 52, and the head portion 51 has a diameter larger than a diameter of each of the needle apertures 31. When the rust removing rod 52 is inserted through one surface of the needle holder 30, the head portion 51 is caught on that surface of the needle holder 30, so that the rust removing needles 50 are fixed to the needle holder 30, respectively.

The peripheral wall 11 has an outer surface 111 which is provided with an anti-skid pattern 112 for the user to hold and achieve the anti-slip effect.

Furthermore, the front cover 20 has an abutting surface 22 facing the needle holder 30, and the pneumatic device with a quick release structure further includes an elastic member 60 which has two ends abutted against the needle holder 30 and the abutting surface 22, respectively, so that the elastic member 60 provides a kinetic energy pushing the impact mechanism 40 to move repeatedly.

In particular, the pneumatic device with the quick release structure further has a coupling member 70 whose circumferential surface is tightly engaged with the inner surface of the peripheral wall 11, and the coupling member 70 has an inner thread 71. It is worth mentioning that the coupling member 70 can be made of iron, aluminum, rubber, etc., but is not limited thereto.

Preferably, the coupling member 70 is made of rubber, so that when high pressure air is injected into the housing 10 to cause displacement of the impact mechanism 40, the coupling member 70 won't get loosened because of vibration, consequently achieving the effect of preventing the coupling member 70 from falling out.

Finally, in this embodiment, the first connecting portion 13 is an inner thread, the second connecting portion 21 is an outer thread for meshing with the first connecting portion 13 in the form of the inner thread. However, the first and second connecting portions 13, 21 can be connected in many ways. According to different situations, the first connecting portion 13 can be a tongue, the second connecting portion 21 can be a groove, so that the first and second connecting portions 13, 21 can be connected to each other via the tongue-and-groove manner, and the tongue-and-groove is a conventional structural configuration, and therefore no further explanation seems necessary. As can be seen from the foregoing, the coupling relationship between the first and second connecting portions 13, 21 is not limited to meshing, and may be detachably coupled to each other by various ways, such as engagement, locking, and tongue-and-groove.

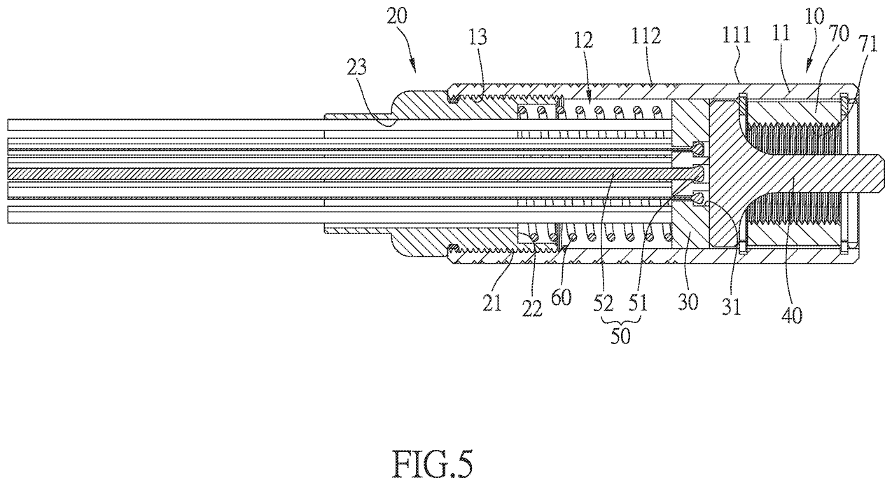

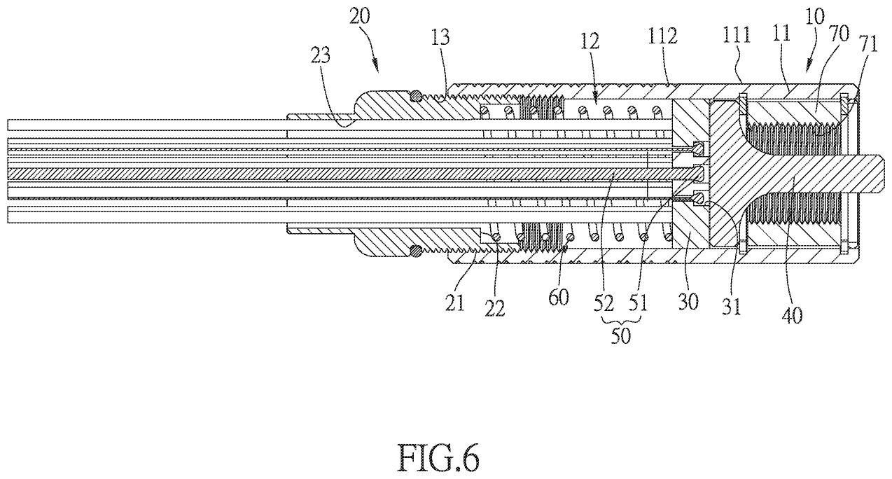

Referring to FIGS. 5 and 6, in another embodiment, the lengths of the first and second connecting portions 21 are longer than the previous embodiment, so that the first connecting portion 13 can be displaced relative to the second connecting portion 21, thereby changing the relative position of the front cover 20 on the housing 10. When the front cover 20 is closer to the needle holder 30 as shown in FIG. 5, the front cover 20 compresses the elastic member 60, and conversely, when the front cover 20 is away from the needle holder 30 as shown in FIG. 6, the front cover 20 releases the elastic member 60, by such arrangements, the elastic pressing force of the elastic member 60 can be adjusted by adjusting the relative position of the front cover 20, which allows the user to change the position of the front cover 20 to obtain the required elastic force, so that when the impact mechanism 40 drives the needle holder 30 to move in a reciprocating motion, the margin (elastic force) of the elastic member 60 can be adjusted according to different pneumatic pressures.

More preferably, the front cover 20 has an inner surface 23, and the respective rust removing needles 50 on the outer periphery of the needle holder 30 can abut against the inner surface 23 of the front cover 20. When the reciprocating motion of the impact mechanism 40 causes vibration, the rust removing needles 50 on the outer periphery of the needle holder 30 can abut against the inner surface 23, thereby slowing the vibration caused by the rust removing needles 50 impacting the impact mechanism 40.

Finally, the front cover 20 can be adjusted to move away from the needle holder 30, so that the inner surface 23 of the front cover 20 abuts against the middle portions of the respective rust removing needles 50 on the outer periphery of the needle holder 30, which makes each of the rust removing needles 50 more stable and less arbitrarily vibrates.

The above is the structural configuration and the connection relationship of the present invention in a preferred embodiment, and the usage mode of the present invention and the achievable effects thereof are as follows:

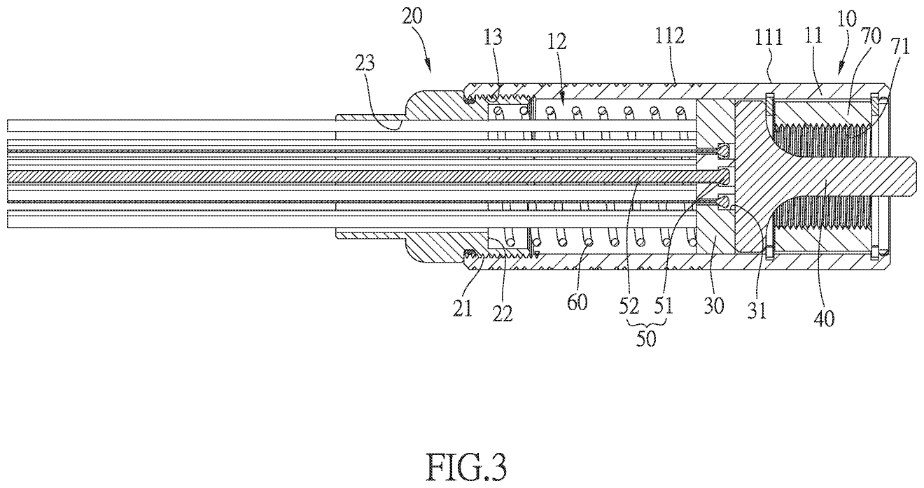

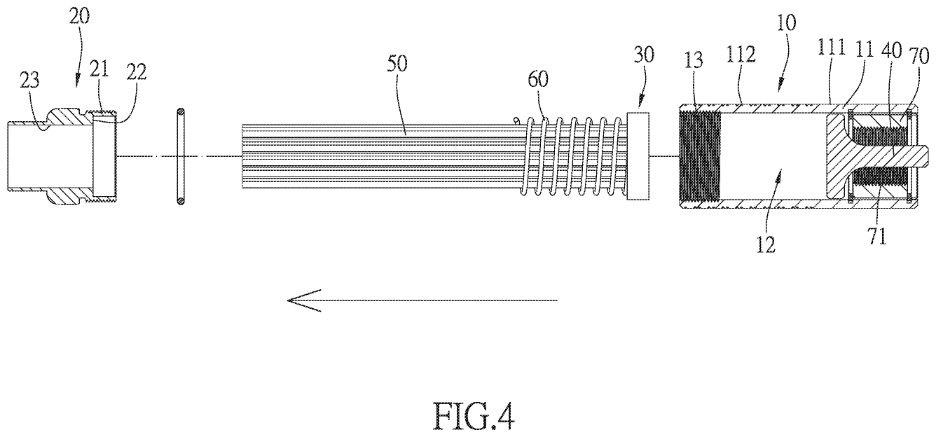

Please refer to FIGS. 3 and 4, when the rust removing needle 50 need to be replaced, the user can directly open the front cover 20 to take the needle holder 30 out of the accommodating space 12, then remove the to-be-replaced rust removing needles 50 from the needle holder 30 and replace them with new ones, and then put the needle holder 30 back to the accommodating space 12, and finally fix the front cover 20 back to the housing, so that the replacement of the rust removing needles 50 is done. Hence, not only the replacement speed is fast, but the high pressure air pipe does not need to be disassembled during the replacement operation, so that the operation of replacing the rust removing needles 50 is simpler and more intuitive.

While we have shown and described various embodiments in accordance with the present invention, it is clear to those skilled in the art that further embodiments may be made without departing from the scope of the present invention.

What is claimed is:

1. A pneumatic device with a quick release structure, comprising:
a housing having a peripheral wall defining an accommodating space for accommodation of an output shaft, and the peripheral wall being provided with a first connecting portion; and
a front cover having a second connecting portion which is detachably coupled to the first connecting portion.

2. The pneumatic device with the quick release structure as claimed in claim 1, wherein the first connecting portion is an inner thread on the peripheral wall, the second connecting portion is an outer thread for meshing with the first connecting portion in the form of the inner thread.

3. The pneumatic device with the quick release structure as claimed in claim 1, wherein the output shaft includes a needle holder and an impact mechanism, and the needle holder is drivingly connected to the impact mechanism.

4. The pneumatic device with the quick release structure as claimed in claim 3, wherein the needle holder is provided with a plurality of needle apertures, in each of the needle apertures is inserted a rust removing needle which has a head portion and a rust removing rod, and the head portion has a diameter larger than a diameter of each of the needle apertures.

5. The pneumatic device with the quick release structure as claimed in claim 3, wherein the front cover has an abutting surface facing the needle holder, and an elastic member is disposed between the needle holder and the abutting surface.

6. The pneumatic device with the quick release structure as claimed in claim 1, wherein the peripheral wall of the housing has an outer surface which is provided with an anti-skid pattern.

7. The pneumatic device with the quick release structure as claimed in claim 1 further comprising a coupling member whose circumferential surface is engaged with an inner surface of the peripheral wall, and the coupling member has an inner thread.

8. The pneumatic device with the quick release structure as claimed in claim 7, wherein the coupling member is made of rubber.

9. The pneumatic device with the quick release structure as claimed in claim 7, wherein the coupling member is made of iron or aluminum.
